(19) United States
(12) Patent Application Publication
(10) Pub. No.: US 2007/0063673 A1
(43) Pub. Date: Mar. 22, 2007

(54) Method and device for equalizing the float voltage of a battery cell

(76) Inventors: James M. DeHaan, Denver, CO (US); Malin L. Jacobs, Centenniel, CO (US)

Correspondence Address: LAW OFFICE OF JOHN L. ISAAC, 7114 W. JEFFERSON AVE., SUITE 100, LAKEWOOD, CO, 80235-2309, US

(21) Appl. No.: 10/644,262

(22) Filed: Aug. 21, 2003

(51) Int. Cl. H02J 7/00

(52) U.S. Cl. 320/118

(57) ABSTRACT

A module and method incorporated thereby is provided for maintaining the float voltage of a battery cell at an optimum fully charged condition while being continuously charged by a float current. The module preferably includes a mechanism for measuring the actual float voltage of the cell, and a circuit is established for variably bypassing the float current directed to the cell. A device is provided for calculating and establishing a predetermined relationship between a desired cell float voltage and a bypass current required to maintain the desired cell voltage. A mechanism then determines a desired bypass current by comparing the measured actual float voltage of the cell with the predetermined relationship. A system compares the actual bypass current with the desired bypass current, and then a mechanism adjusts the actual bypass current to equal the desired bypass current. This arrangement equalizes the cell float voltage by regulating the bypass current diverted from the cell which in turns varies the actual float current applied to the cell. In one most preferred form, the module is powered from the actual battery cell being monitored by the module.

### BACKGROUND OF THE INVENTION

1. Field of the Invention

The present invention relates generally to the field of battery charging and, more particularly, to the process of equalization of the charge in multiple cells of a battery. Specifically, the present invention relates to a device and method for continuous monitoring and regulation of individual cell voltage in series connected multiple battery cells to prevent both under charging and overcharging of individual cells.

2. Description of the Prior Art

Series connected battery cells are being utilized in many applications such as telecommunication power supplies, electric vehicles, uninterruptible power supplies, power plants, switchyard protection, communications systems and photovoltaic systems, to name just a few. Battery life is one of the major factors presently limiting the realization of economical systems. It has been known for many years that batteries perform optimally if the cells thereof are of the same chemistry and electrical capacity and are individually charged to the same cell voltage. However, the most common battery applications involve series strings of individual cells which are generally charged from a single battery charger. In such instances, slight differences in individual cell construction, chemistry, internal losses and/or other factors result in the individual cells receiving slightly different charges from the same charger source as indicated by slightly different voltages at the cell terminals.

Thus, while all the cells are being charged identically, the result of these slight cell differences is that some cells become overcharged while others are under charged within the same battery. This differential in charging between individual cells of a battery can cause a dramatic reduction in the life of such a battery, since maintenance of cells at an equalized charge level is critical for enhancing battery life.

The purpose of individual cell equalization, then, is to maximize both the individual cell and as well as the overall battery life in addition to minimizing maintenance costs associated with keeping the battery on line and maximally functional. Ideally, in the charge-discharge cycle of battery use, the individual cells and the battery should be fully charged but not overcharged, as overcharging reduces battery life. The optimal cell voltage of a fully charged battery is a function of the cell chemistry and temperature. For example, at a temperature of 20 degrees C., nickel-cadmium cells exhibit a fully charged, open-circuit voltage of 1.29 volts, while Lithium-ion cells exhibit a voltage of 4.2 volts. The most common battery chemistry in industry as a whole is a lead-acid combination, which typically exhibits an open-circuit voltage of 2.1 volts.

In most applications, the battery is charged by a constant voltage system. When the battery charge is low, large charging currents flow thereby rapidly charging the battery. As the battery charge rises, the battery voltage rises thereby causing the charging current to drop. If all individual cells were in fact identical, the proper choice of charging voltage would result in all cells reaching full charge simultaneously with the charging current reduced to a small float current. However, since no two cells are in reality completely identical, some cells will reach full charge before others. Consequently, at the final float current, some cells are overcharg d, some are fully charged and other cells are under charged. Moreover, should the charging system malfunction and the charging voltage rise above nominal, many of the battery cells will become overcharged and may be damaged.

There have been a number of different approaches to battery cell voltage equalization used in the past to compensate for the above problems. Many are illustrated in a variety of prior ART patent references including U.S. Pat. No. 6,150,795, No. 6,271,646, No. 6,369,546, No. 6,417,646, No. 6,437,539, No. 6,452,363, No. 6,459,236 and No. 6,489,753, as well as U.S. patent application publications No. US 2002/0084770 and No. US 2002/0175655.

The simplest approach to the above problems involves placing passive resistors across the cell terminals. The higher cell voltage of those cells with a higher charge will cause a higher discharge current to pass through the corresponding resistors, which in turn tends to equalize the cell voltage and thus the state of charge. The advantage of this approach is its simplicity. However, the disadvantages of this approach are that the resistors dissipate power even if the cell is not overcharged. Moreover, to be effective the resistance value must be relatively small. Consequently, the resistor conducts a relatively high current, often ten or more times the cell charging current. The net result is that a large amount of energy is wasted as heat in the resistors. Finally, resistors cannot fully equalize the cell voltages. Therefore, the cells will remain either overcharged or undercharged, though to a lesser extent than would be the case without the equalizing resistors.

Another approach to this problem involves measuring the cell voltage. If the cell voltage exceeds a predetermined value based on the cell chemistry, a fixed resistor positioned across the cell terminals is switched on until the cell voltage drops to the proper value, at which time the fixed resistor is then switched off. In addition to the simplicity of the prior described approach, this approach has an additional advantage in that power is not dissipated in the resistor unless the cell is actually overcharged. The major disadvantage of this particular approach, however, is that the cell voltage is not constant, and the cells continuously cycle between being overcharged and being undercharged.

Still another approach to this problem is to use an adjustable constant-current charger. Such a charger applies a relatively large charge current to a battery, and as the battery charges, the charge current is progressively reduced until it reaches a float current value, at which time the individual cells of the battery are completely charged. The advantage of this approach is that overcharging of the battery as a whole is kept to a minimum, and only one system per battery, not per individual cell, is required. The main disadvantage to this arrangement is that individual cells are not equalized, resulting in some cells still being overcharged or undercharged.

Yet another prior art approach to the above outlined problem is that of proportionately bypassing the charging circuit around those cells that are overcharged. This approach measures cell voltage and the cell float current to determine how much current should be shunted around the cell. Sophisticated electronics are used for these measurements. The magnitude of the shunted current varies with the state of charge (voltage) of the individual cell. The major disadvantage of this approach is the difficulty of non-intrusively measuring the cell float current. Shunt measuring elements generally degrade battery performance because of the resistance they introduce into the battery current path. Hall-effect, or other magnetic field sensing approaches to current measurements, have the disadvantage of system complexity and the need for periodic calibration.

Still another system also utilized to deal with the above problem, attempts to non-intrusively monitor every parameter that affects or indicates the state of charge of each cell. The system is quite complex and is disclosed in an EPRI report dated September 2000, entitled “Valve-Regulated Battery Monitoring System”. The parameters measured by the system including temperature, cell voltage, charging current, specific gravity, sediment formation at the bottom of the cell, and internal cell resistance. All this data is processed by a central microprocessor, and the amount of current needed to bypass the cell is determined. This system sends the measured data to a host computer which records trends over time so that maintenance personnel can determine when to replace the battery or individual cells. This approach has demonstrated a definitive improvement in battery life. However, the disadvantage to this particular system is the complexity and cost of the various sensors and a central computer required to process all the data.

Another disadvantage in all of the above systems, except for the use of passive resistors as described in the very first system above, is that they all require external power to operate them. This external power is necessary because of the difficulty of powering systems from very low individual cell voltages. For lead-acid batteries, for instance, this voltage is about 2.25 volts, the cell voltage under float-current conditions. The engineering necessary to meet the isolation requirements and at the same time provide each cell-monitoring module with power adds greatly to the cost and complexity of each of the systems.

Consequently, as can be seen from the above, there remains a needed in the industry for a simple and inexpensive approach to equalizing the charge of individual cells of a battery while preventing overcharging and under charging yet avoiding complex and the sophisticated monitoring and computer systems.

### SUMMARY OF THE INVENTION

Accordingly, it is one object of the present invention to provide a method and device for equalizing the float voltage of a battery cell receiving a float charge.

It is another object of the present invention to provide a system for automatically maintaining each of the individual cells of a multicell battery at an optimum state of charge.

Yet another object of the present invention is to provide such a battery equalization system that does not require an external power source.

Still another object of the present invention is to provide a module attachable to an individual battery cell and adapted to maintain such cell at an optimum fully charged condition without over or under charging while being continuously charged by a float current.

To achieve the foregoing and other objects and in accordance with the purpose of the present invention, as embodied and broadly described herein, a module and method incorporated thereby is provided for maintaining the float voltage of a battery cell at an optimum fully charged condition while being continuously charged by a float current. The module preferably includes a mechanism for measuring the actual float voltage of the cell, and a circuit is established for variably bypassing the float current directed to the cell. A device is provided for calculating and establishing a predetermined relationship between a desired cell float voltage and a bypass current required to maintain the desired cell voltage. A mechanism then determines a desired bypass current by comparing the measured actual float voltage of the cell with the predetermined relationship. A system compares the actual bypass current with the desired bypass current, and then a mechanism adjusts the actual bypass current to equal the desired bypass current. This arrangement equalizes the cell float voltage by regulating the bypass current diverted from the cell which in turns varies the actual float current actually applied to the cell.

In one particular aspect of the module of the invention, the predetermined relationship between a desired optimum cell float voltage and a bypass current required to maintain the desired optimum cell voltage is based on the formula
y=mx+b
wherein y is the bypass current, with 0≦y≦a maximum regulation current, x is the cell voltage, m is the slope of the plot of bypass current vs. cell float voltage, and b is the current offset. In one specific application, the slope m and the current offset b are selectively adjustable factors. In another application, the slope “m” includes a zero bypass current intercept point wherein there is a cell float voltage “x” below which there is no bypass current generated, which establishes the current offset “b” and prevents undercharging of said cell. Additionally, the slope “m” may further include a maximum voltage regulation point which is the maximum cell float voltage that can be actively regulated by the bypass current to prevent overcharging of the cell.

In another application of the invention, the mechanism for determining the desired bypass current in the module is based on comparing the measured actual float voltage level of the cell and the desired bypass current intercept point. In one aspect of this, the system for comparing the desired bypass current with the actual measured bypass current is in the form of a comparator circuit member which includes a member for generating a control signal. The module of the invention may further include a proportional current bypass element which is adapted to receive the control signal and in turn adjust the actual bypass current until the actual bypass current level equals the desired bypass current level.

In still another aspect of this application of the invention, the module further includes a plurality of cell condition indicator elements which are adapted to indicate the charge condition of the cell at the time the comparator circuit member compares the desired bypass current to the actual bypass current. The indicator elements provide signals which indicate that the cell is in one of three conditions, that of an overcharged condition, a fully charged condition or an undercharged condition. In one form, the cell condition indicator elements comprise three different colored indicator lights with each color representing one particular cell condition.

In another application of the invention, the cell indicator elements further include a mechanism for automatic signaling and notification of a remote station of an overcharged or an undercharged cell condition.

In one form of the invention, the battery cell is one of a plurality of series connected cells which make up a single battery, each cell having one of the aforementioned modules associated therewith.

In still another application of the invention, a method is provided for equalizing the float voltage of a battery cell which is continuously receiving a float charge. The method includes monitoring the actual float voltage of the cell while creating a float charge bypass circuit for the cell. The bypass current passing through the bypass circuit is measured, and a predetermined relationship is then established between an optimum desired cell float voltage and the bypass current required to maintain an optimum cell float voltage. The monitored actual float voltage level of the cell is then compared with the desired optimum cell float voltage level, and a desired bypass current is then computed based on the previously established predetermined relationship. The computed desired bypass current is compared with the actual measured bypass current; and the actual bypass current is then adjusted to equal the computed desired bypass current. In this manner, the cell float voltage is equalized at the optimum level by regulating the bypass current shunted away from the cell and thereby varying the float current actually applied to the cell.

In yet another application of the invention, a system is provided for automatically maintaining each of the individual cells of a multicell battery at an optimum state of charge. The system includes a device for providing a float current to the cells for continuously charging the cells. A float current bypass circuit is associated with each of the cells and is adapted to selectively vary and divert portions of the float current to bypass the associated cell. A mechanism provides for measuring the actual bypass current flowing through the bypass circuit for each cell and compares the actual bypass current with a desired bypass current based on a preestablished relationship between the bypass current and a desired optimum float voltage for the cell. Finally, a device is provided for selectively regulating the actual bypass current for each cell to match the desired bypass current to thereby equalize the float voltage of the associated cell.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a schematic diagram illustrating a preferred embodiment of the module and method of the present invention; and

FIG. 2 is a graphic representation of the predetetermined relationship between the bypass current and the float voltage of a cell as utilized in the present invention.

### DETAILED DESCRIPTION OF THE EXEMPLARY EMBODIMENTS

Large battery systems are often utilized as backup power sources for municipal power grids, electric generation dams, and the like. The difficulty arises in maintaining such battery systems at optimum charge levels without fluctuating the voltage of individual cells between overcharged and undercharged conditions. The present invention evolved as a simple yet effective device and method for a complete equalization of float voltage charge for each individual battery cell regardless of any particular differences in cell chemistry or construction therebetween. The invention is based on the concept of establishing a float current bypass circuit for each cell, measuring the current passing through such bypass circuit, and then adjusting this bypass current to maintain the cell float voltage at an optimum level.

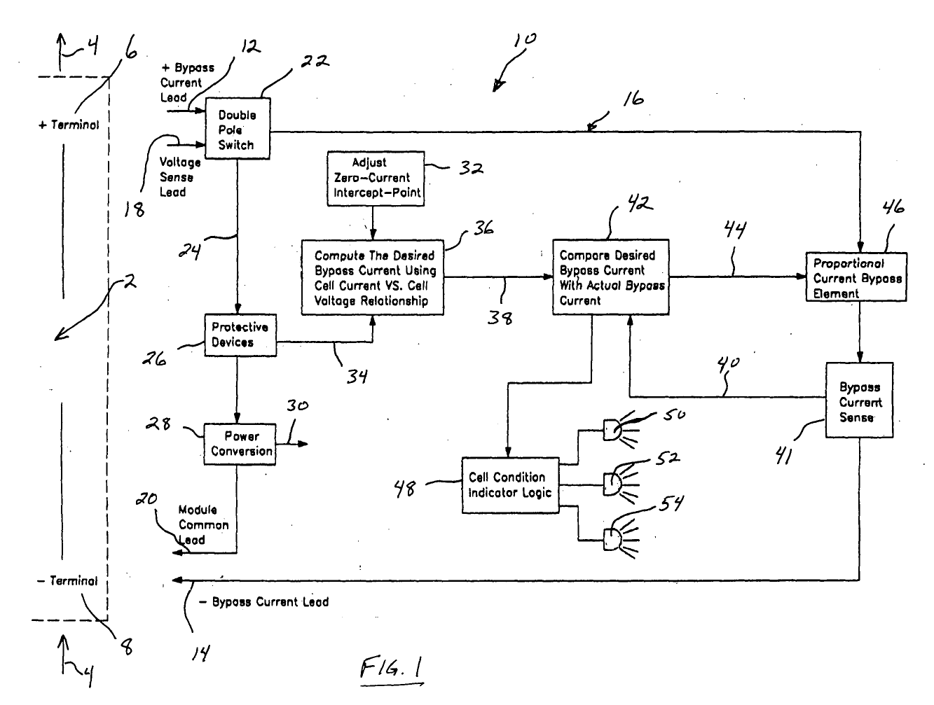

Referring now with particularity to FIG. 1, a preferred embodiment of the present invention is illustrated therein. It should be understood, however, that there are numerous different variations which can be made to the specific illustrated components and which still fall within the purview of the scope of the invention as claimed herein. In FIG. 1, a battery cell voltage equalizer module 10 is illustrated. The module 10 is constructed in accordance with the present invention and embodies the method thereof.

A typical battery cell 2 of any known construction and chemistry is shown and is either an individual, stand-alone cell or one of a plurality of cells that comprise a battery. A float current 4 is typically applied continuously to the cell 2 to provide a float charge on a continuous basis to ensure that the cell 2 remains in a fully charged condition. As described above, this typically does not account for a variety of variables that cause either overcharging or undercharging of the cell 2 as discussed above.

The module 10 is preferably connected across the positive and negative cell terminals 6,8, respectively, of the cell 2. In preferred form, a positive bypass current lead 12 is connected to the positive terminal 6 of the cell 2, while a negative bypass current lead 14 is connected to the negative terminal 8 of the cell 2. In this manner, a bypass circuit 16 is created within the module 10. In addition, a cell voltage monitoring lead 18 is also attached to the positive terminal 6 of the cell 2, while a module common lead 20 is secured to the negative terminal 8 of the cell 2.

A double-pole switch 22 is preferably provided for allowing the module 10 to be disconnected from the cell 2 without physically disconnecting the leads 12, 14, 18 and 20. Such an electrical disconnection would be desirable during, for example, the performance of periodic battery maintenance, such as measuring the internal resistance of a cell. When the switch 22 is in an “on” position, the positive bypass current lead 12 is electrically connected to the bypass circuit 16, while the voltage monitoring lead 18 electrically generates a power and voltage sense signal 24. The power and voltage sense signal 24 is preferably directed to a protective devices block 26, which protects the electronics of the module 10 from overvoltage transients that might appear across the cell 2 or be induced in the leads that connect the module 10 to the cell 2.

The voltage monitoring lead 18 and the module common lead 20 provide power to the module 10 at a very low current, approximately 0.04 Ampere. This current stays relatively constant regardless of how much charging current is being bypassed around and diverted from the cell 2 through the bypass circuit 16 of the module 10. The voltage monitoring lead 18 and the common module lead 20 also provide the cell 2 float voltage to the module 10 for sensing. The cell-voltage changes being sensed or monitored are quite small, i.e. plus or minus 0.01 volt. Actual tests of the module 10 demonstrated that the leads 12, 18 and 14, 20 cannot be combined because of excessive voltage drop in the circuitry, a voltage drop that changes significantly as the bypass current changes. The voltage drop through a practical sized single lead when current is being bypassed around the cell 10 would cause unacceptable errors in the measured cell voltage and would result in improper module operation. The current required to power the module 10, however, is small enough that no appreciable error is introduced by powering the module 10 through the same leads that measure the cell voltage.

A power conversion block 28 is preferably provided and converts the low cell-voltage, approximately 1-5 volts DC, to a higher voltage, for example 12 volts DC, to power the module electronics through the lead 30. Consequently, the module 10 requires no outside power source other than the cell 2 to which it is connected. In addition, the input voltage range is such as to accommodate all known cell chemistries including lithium-ion, lead-acid and the like.

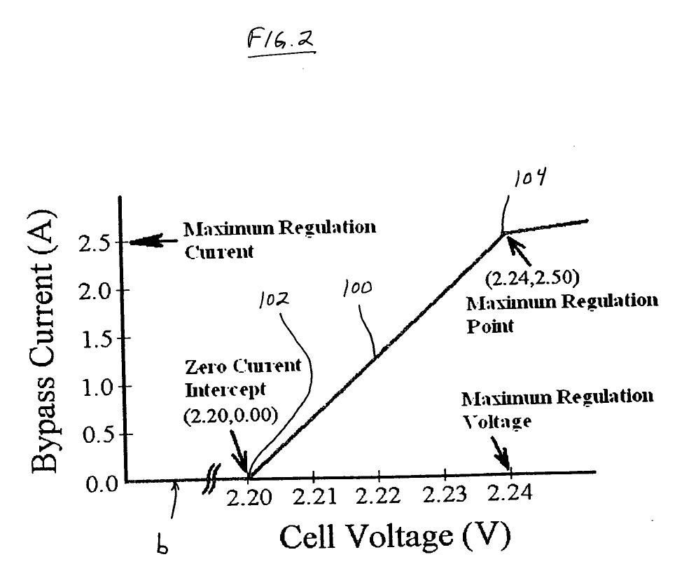

To carry out the method of the present invention, the float voltage of the battery cell 2 is equalized even though the cell 2 is continuously receiving a float charge 4. The actual float voltage of the cell 2 is measured by the leads 18, 20 while creating a float charge bypass current through the module bypass circuit 16. The bypass current passing through the bypass circuit 16 is measured, and a predetermined relationship as described below in FIG. 2 is then established between an optimum desired cell float voltage and the bypass current required to maintain this optimum cell float voltage. The monitored actual float voltage level of the cell 2 is then compared with the desired optimum cell float voltage level, and a desired bypass current is then computed based on the previously established predetermined relationship of FIG. 2. The computed desired bypass current is compared with the actual measured bypass current; and the actual bypass current passing through the circuit 16 is then adjusted to equal the computed desired bypass current. In this manner, the cell float voltage is equalized at an optimum level by regulating and shunting variable bypass current through the circuit 16 and thereby varying the float current actually applied to the cell by the leads 4.

Referring now to FIG. 2, a typical plot of cell voltage vs. desired bypass current is illustrated. In this particular FIG. 2, the plot 100 is a straight line. However, present technology will allow the plot 100 to be any desired relationship between the cell voltage and the bypass current. In general, there will be a cell voltage below which there should be no bypass current. This point is labeled “zero current intercept” at 102. In this particular invention, the zero current intercept 102 is actually a variable current intercept point because it is user adjustable so that the plot 100 may be moved along the cell voltage line as desired. There will also be a maximum regulation point 104 which is the maximum voltage the module 10 can actively regulate the bypass current, and the bypass current at that voltage. The present implementation relates the bypass current and cell voltage via the straight line equation (1) below.
y=mx+b (1)
wherein
y=the bypass current with 0≦y≦maximum regulation current;
x=the cell float voltage;
m=the slope of the plot 100 (user adjustable); and
b=the current offset (user adjustable).

Referring back to FIG. 1, the module 10 preferably includes a block 32 which contains electronics to adjust the desired, in this instance zero, intercept point 102 of FIG. 2. A voltage sensing signal 34 and the zero intercept point 102 from the block 32 are applied to the block 36 which computes the desired bypass current in accordance with the relationship established in FIG. 2. A desired bypass current signal 38 is generated by the block circuitry 36 and is compared with the actual bypass current signal 40 generated by a bypass current sensor block 41 at a comparator element 42. This in turn provides a control signal 44 which is directed to a proportional current bypass element 46. This element 46 adjusts the actual bypass current traveling through the circuit 16 until the desired bypass current and the actual bypass current are equal to each other. In preferred from, the sensor block 41 and the bypass element 46 are self protected from transients. The bypass current sensor block 41 senses the actual bypass current in the circuit 16 and provides that information to the comparator element 42.

In one preferred form of the invention, information from the comparator element 42 is preferably supplied to a cell condition indicator logic circuit 48. The logic circuit 48 in turn provides outputs to a plurality of cell state visual indicators 50, 52 and 54. In preferred form, the indicators 50-54 are a plurality of light emitting diodes. Only one of the indicators 50-54 may operate at any one particular time and indicates whether the voltage of cell 2 is high (i.e. overcharged), normal (i.e. fully charged), or low (i.e. undercharged). In this specific implementation, the indicator light 50 is red, the light 52 is blue and the light 54 is amber. Thus, if a cell indicator signals that the voltage is too high, the bypass current will be maximized to force less current through the cell 2. On the other hand, if the voltage is indicated as being too low, the bypass current can be adjusted to zero so as to maximize the current flowing through the cell 2 to fully charge it. Moreover, one can move the entire slope 100 of FIG. 2 to the right or the left along the cell voltage line as desired. Finally, the indicators 50-54 may also be attached to signal a remotely located or isolated device for monitoring and automatic notification in the event a cell becomes under or over charged.

It should be understood that the members and elements of module 10 may be in a variety of different forms. For example, the element 36 which computes the desired bypass current may be in either analog or digital form, although the preferred form utilizes analog circuitry. Digital circuitry would be desirable if a complicated algorithm cell voltage to bypass current were desired. Moreover, a digital implementation might combine the multiple members and elements into a single block. For example, the elements 32, 36, 42 and 48 could be implemented in a single microprocessor.

As can be seen from the above, the present invention provides a simple yet effective device, system and method for equalizing battery cell float voltage. The invention permits a single module per cell to monitor and adjust the cell float voltage by the technique of measuring and adjusting not the float charge directly but rather the bypass current. The module constructed in accordance with the present invention does not require outside power sources since it can readily be operated from a minute power charge from the cell that it is monitoring. This self power feature does not drain charge and/or power away from the monitored cell since the power requirements are so minor. Moreover, a system is provided for automatically maintaining each of the individual cells of a multicell battery at an optimum state of charge using the present invention. Additionally, the invention provides a module which is attachable to an individual battery cell and adapted to maintain such cell at an optimum fully charged condition without over or under charging while being continuously charged by a float current, thereby enhancing the life of the battery. Finally, the present invention provides cell voltage equalizers that are both inexpensive to manufacture as well as to use.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

We claim:

1. A method for equalizing the float voltage of a battery cell continuously receiving a float charge, said method comprising:
monitoring the actual float voltage of the cell;
creating a float charge bypass circuit for said cell;
measuring the bypass current passing through said bypass circuit;
establishing a predetermined relationship between an optimum desired cell float voltage and the bypass current required to maintain said optimum cell float voltage;
comparing the monitored actual float voltage level of the cell with said optimum desired cell float voltage level and computing a desired bypass current based on said predetermined relationship;
comparing the computed desired bypass current with the actual measured bypass current; and
adjusting the actual bypass current to equal said computed desired bypass current, thereby equalizing the cell float voltage at said optimum level by regulating said bypass current and thereby varying the float current applied to said cell.

2. The method as claimed in claim 1, wherein said predetermined relationship comprises the formula
y=mx+b
wherein
y=the bypass current with 0≦y≦maximum regulation current;
x=the cell float voltage;
m=the slope of the plot of bypass current vs. cell float voltage; and
b=the current offset.

3. The method as claimed in claim 2, wherein the value of “m” is user adjustable.

4. The method as claimed in claim 2, wherein the value of “b” is user adjustable.

5. The method as claimed in claim 2, wherein the slope “m” includes a zero bypass current intercept point wherein there is a cell voltage “x” below which there is no bypass current to establish said current offset “b”, and wherein the slope “m” further includes a maximum voltage regulation point which is the maximum cell float voltage that can be actively regulated by the bypass current.

6. The method as claimed in claim 5, wherein the step of computing the desired bypass current is based on comparing the monitored actual float voltage level of the cell and its intercept point along the slope “m”.

7. The method as claimed in claim 1, wherein the step of comparing said desired bypass current with the actual measured bypass current includes the generation of a control signal directly actuating a proportional current bypass element which in turn adjusts the actual bypass current until the actual bypass current equals the desired bypass current.

8. The method as claimed in claim 1, wherein said method further includes the step of indicating the charge condition of the cell as the desired bypass current is first compared to the actual bypass current by providing a signal which indicates that the cell is in one of three conditions, that of an overcharged condition, a fully charged condition or an undercharged condition.

9. A system for automatically maintaining each of the individual cells of a multicell battery at an optimum state of charge, said system comprising:
a device for providing a float current to said cells for continuously charging said cells;
a float current bypass circuit associated with each said cell adapted to selectively vary and divert portions of the float current to bypass the said associated cell;
means for measuring the actual bypass current for each said cell flowing through said bypass circuit and comparing said actual bypass current with a desired bypass current based on a preestablished relationship between said bypass current and a desired optimum float voltage for said cell; and
means for selectively regulating the actual bypass current for each said cell to match said desired bypass current to thereby equalize the float voltage of said associated cell.

10. The system as claimed in claim 9, wherein said float current bypass circuit, said actual bypass measuring means and said actual bypass current regulating means, for each said cell, are disposed in a single module electronically associated with said cell.

11. The system as claimed in claim 10, wherein each said module is powered by the cell with which it is electronically associated.

12. The system as claimed in claim 11, wherein the current required to power each said module comprises approximately 0.04 Ampere.

13. The system as claimed in claim 9, wherein said preestablished relationship is based on the formula:
y=mx+b
wherein
y=the bypass current with 0≦y≦maximum regulation current;
x the cell voltage;
m=the slope of the plot of bypass current vs. cell float voltage; and
b=the current offset.

14. A module for maintaining the float voltage of a battery cell at an optimum fully charged condition while being continuously charged by a float current, said module comprising:
means for measuring the actual float voltage of said cell;
a circuit for variably bypassing and diverting a potion of the float current directed to said cell;
means for calculating and establishing a predetermined relationship between a desired optimum cell float voltage and the bypass current required to maintain said desired optimum cell float voltage;
means for determining a desired bypass current by comparing the measured actual float voltage of said cell with said predetermined relationship;
means for comparing the actual bypass current with the desired bypass current; and
means for modifying the actual bypass current to equal said desired bypass current thereby equalizing the cell float voltage by regulating the bypass current diverted from said cell.

15. The module as claimed in claim 14, wherein said predetermined relationship comprises the formula
y=mx+b
wherein
y=the bypass current with 0≦y≦a maximum regulation current;
x=the cell voltage;
m=the slope of the plot of bypass current vs. cell float voltage; and
b=the current offset.

16. The module as claimed in claim 15, wherein said slope m and said current offset b are selectively adjustable factors.

17. The module as claimed in claim 15, wherein the slope “m” includes a zero bypass current intercept point wherein there is a cell float voltage “x” below which there is no bypass current generated to establish said current offset “b” and prevent undercharging of said cell, and wherein the slope “m” further includes a maximum voltage regulation point which is the maximum cell float voltage that can be actively regulated by the bypass current to prevent overcharging of the cell.

18. The module as claimed in claim 17, wherein said means for determining the desired bypass current is based on comparing the measured actual float voltage level of the cell and the zero bypass current intercept point.

19. The module as claimed in claim 15, wherein said means for comparing said desired bypass current with the actual measured bypass current comprises a comparator circuit member and includes means for generating a control signal, and said module further includes a proportional current bypass element adapted to receive said control signal and in turn adjust the actual bypass current until the actual bypass current equals the desired bypass current.

20. The module as claimed in claim 19, wherein said module further comprises a plurality of cell condition indicator elements adapted to indicate the charge condition of the cell at the time the comparator circuit member compares the desired bypass current to the actual bypass current, said indicator elements providing signals which indicate that the cell is in one of three conditions, that of an overcharged condition, a fully charged condition or an undercharged condition.

21. The module as claimed in claim 20, wherein said cell condition indicator elements comprise three different colored indicator lights, each color representing one particular cell condition.

22. The module as claimed in claim 20, wherein said cell indicator elements further comprise means for automatic notification to a remote station of an overcharged or an undercharged cell condition.

23. The module as claimed in claim 15, wherein said battery cell is one of a plurality of series connected cells comprising a single battery, each said cell having one said module associated therewith.
